(19) United States
(12) Patent Application Publication
(10) Pub. No.: US 2026/0367388 A1
(43) Pub. Date: Nov. 19, 2026

(54) A LIGHT MANIPULATING DEVICE

(71) Applicant: OPTOFIDELITY OY, Tampere (FI)

(72) Inventors: Ilkka ALASAARELA, Tampere (FI); Riku KYLLONEN, Tampere (FI); Thomas KERST, Tampere (FI); Jukka AHOLA, Tampere (FI); Ari NEVALAINEN, Tampere (FI)

(21) Appl. No.: 19/143,087

(22) PCT Filed: Dec. 15, 2023
(86) PCT No.: PCT/FI2023/050704

§ 371 Date: Jun. 25, 2025

Related U.S. Application Data
(60) Provisional application No. 63/477,866, filed on Dec. 30, 2022.

(51) Int. Cl. G02B 26/08; G02B 27/00

(52) U.S. Cl. CPC G02B 26/0883; G02B 27/0037; G02B 26/0808; G02B 26/0816

(57) ABSTRACT

There is provided a light manipulating device comprising a first aperture for entering light into the light manipulating device; and a second aperture for outputting light propagated through the light manipulating device; wherein the light manipulating device is configured to image a first image surface visible by the first aperture via the light manipulating device and through the second aperture to a second image surface.

### TECHNICAL FIELD

There is provided a light manipulating device.

### BACKGROUND

A light manipulating device is able to affect electromagnetic radiation, such as light, which passes through the light manipulating device.

### SUMMARY

An embodiment of the light manipulating device is an optical system which manipulates electromagnetic radiation, such as light, as exemplarily depicted in FIG. 1. The light manipulating device may receive light through at least one aperture, the first aperture, and deliver at least part of the received light through at least one other aperture, the second aperture. The light manipulating device may manipulate light in a predetermined manner between the location where the light is received and the location where the light is delivered outside the light manipulating device.

The light manipulating device may also receive light through the second aperture, and deliver at least part of the received light through the first aperture. The light manipulating device may also operate simultaneously in both directions between the first and the second apertures. The first aperture and the second aperture may overlap or be partially or fully the same physical apertures, too. The light manipulating device may have more than one aperture which receives light and/or more than one aperture which delivers light.

The first aperture may also be called as a first image surface and the second aperture may also be called as a second image surface.

The light manipulating device may be an optical device such as a lens or a lens system, or an optical system which contains lenses and reflecting elements such as mirrors, for example. The first aperture may be an input aperture through which the light enters to the optical device, and the second aperture may be an output aperture through which the light exits from the optical device, or vice versa.

### BRIEF DESCRIPTION OF THE DRAWINGS

FIG. 1 shows as a simplified manner a light manipulating device, in accordance with an embodiment;

FIG. 2 depicts an embodiment of the light manipulating device, which is arranged to manipulate light between the first image surface and the second image surface in predetermined manner, in accordance with an embodiment;

FIG. 3 depicts an example of the light manipulating device which has a first pupil and a second pupil, in accordance with an embodiment;

FIG. 4 depicts an embodiment of the light manipulating device, having a third group and a fourth pupil, which acts as the aperture stop, in accordance with an embodiment;

FIG. 5 depicts an embodiment of the light manipulating device with a first working distance along the optical axis between the first pupil and the first powered surface;

FIG. 6 shows the light manipulating device, configured to be able to have a first light redirecting element between the first pupil and the first group, in accordance with an embodiment;

FIG. 7 shows the light manipulation device, configured to be able to have a second light redirecting element between the first powered surface and the second image surface, in accordance with an embodiment;

FIG. 8 shows the light manipulation device, configured to be able to have a third light redirecting element between the second pupil and the second image surface;

FIG. 9 presents an advantage of the light redirecting element;

FIG. 10 shows an embodiment of the light manipulating device, with the first light redirecting element implemented by a prism;

FIG. 11 shows otherwise the same light manipulating device than FIG. 10 but in which the fold prism is replaced by a glass block which is optically substantially equivalent to the fold prism but does not fold the beam;

FIG. 12 shows a configuration of the light manipulating device having the glass block between the first pupil and the first group;

FIG. 13 shows still another configuration of the light manipulating device, where fold prism is integrated with the first lens element so that the first powered surface is a surface of the fold prism

FIG. 14 shows an exemplarily light manipulating device in which the light redirecting element is working as a beamsplitter;

FIG. 15 shows another exemplarily light manipulating device in which the light redirecting element is working as a beamsplitter; and

FIG. 16 shows an exemplary embodiment of the light manipulating device, in accordance with an embodiment.

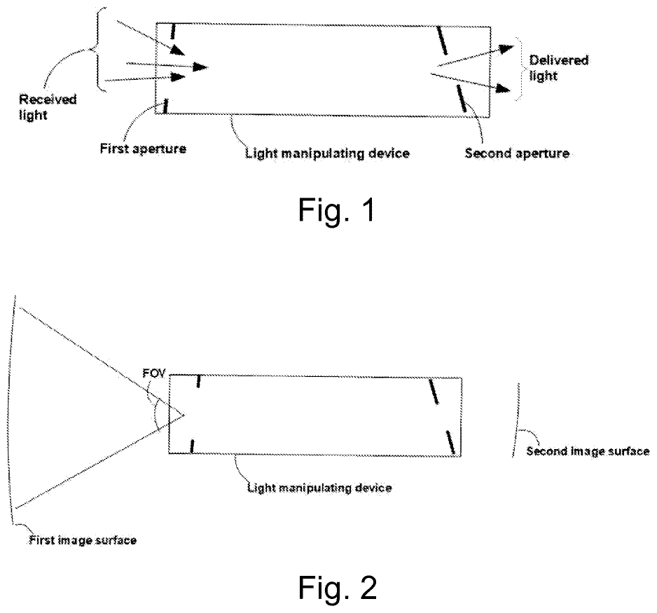

### DETAILED DESCRIPTION

FIG. 2 depicts an embodiment of the light manipulating device, which is arranged to manipulate light between the first image surface and the second image surface in predetermined manner. The light manipulating device may operate in both directions: from the first image surface to the second image surface, or from the second image surface to the first image surface, or both directions simultaneously.

The wavelength of the light may be within a range from ultraviolet to long wavelength infrared, i.e., from 10 nm to 50 micrometers for example, or within a range from visible to near-infrared, i.e., from 350 nm to 1000 nm for example, but not limited to that. The light manipulating device may be said to operate with certain wavelength range or wavelengths, and correspondingly have an operation wavelength range, when it is capable of manipulating the light in that wavelength range or wavelengths in a meaningful way. The operation wavelength range may also have narrower than above-mentioned bandwidths, such as spectral bandwidth of any light source such as light emitting diodes (LEDs) or lasers for example. The operation wavelength may also be defined or restricted by the light manipulating device, for example, by means of filters, such as absorbing glass filters, or interference filters, or by any means which manipulate or modulate spectral content of light.

The light manipulating device may be an optical system, which manipulates light by using optical components such as lenses, mirrors, curved mirrors, diffraction gratings, modulators for example.

The light manipulating device may approximately image the first image surface to the second image surface. The light manipulating device may be an optical system, for example, an optical lens, which receives light through the first aperture and delivers the light through the second aperture, and images the first image surface to the second image surface.

The light manipulating device may be a lens, a lens assembly, or a lens system, which may be an image forming device. The first aperture may be the input aperture of the lens, such as, for example, the clear aperture of the first air-glass interface in direction of light propagation, and the second aperture may be the output aperture of the lens, such as the clear aperture of the last glass-air interface for example. The input aperture and output aperture may be different than the entrance and exit pupils of the lens, although they also may overlap or coincide with each other. The first image surface may be the object plane of the lens, and the second image surface may be the image plane of the lens. As well, the second image surface may be the object plane of the lens, and the first image surface may be the image plane of the lens. The first image surface and the second image surface may be optical conjugates. The first image surface and/or the second image surface may be real or virtual. For example, the first image surface may be a virtual object plane as seen through another optical system. The second image surface may be a real or a virtual image of the first image surface, or the first image surface may be a real or a virtual image of the second image surface. The other image surfaces may contain a real or a virtual image of the first image surface or the second image surface, too.

### Image Surfaces

The light manipulating device may also comprise other image surfaces: a third image surface, a fourth image surface, and so on. Some of the other image surfaces may be conjugates to the first image surface and/or the second image surface. Some of the other image surfaces may be intermediate image surfaces inside or outside the light manipulating device.

The first image surface, the second image surface and the other image surfaces may be called as image surfaces in general. The image surfaces may be planar or curved. The image surfaces may be located outside or inside the light manipulating device, on any side of the light manipulating device, or at infinity on any side of the light manipulating device. The image surfaces may be separate or overlap or coincide with each other.

### Field-of-View

The field-of-view (FOV) of the light manipulating device may be defined as a spatial or angular extent of the first image surface or the second image surface. For example, FOV may be defined similar to conventional photographic objectives. The FOV may be expressed in angular terms and units as viewed from a predetermined location in respect to the light manipulating device, such as from the first aperture, or from the second aperture, or from the entrance pupil, or from the exit pupil, just to mention some. The FOV may also be expressed in spatial terms and units in the first image surface or in the second image surface.

The field-of-view may be approximately circular for example. The field-of-view may be non-circular, too, for example, elliptical, rectangular, distorted rectangle, or any needed shape. The field-of-view may have largest diagonal more than 60 degrees, or more than 90 degrees for example.

### Imaging-Term

The terms “imaging”, “being an image of”, “being a conjugate of”, or “forming an image” etc. may be used to mean conventional “imaging” term in photographic or optical terminology, but it is not restricted to that. The terms may be used to mean any predetermined relation between any surfaces. The terms may be used for any relation between any at least two surfaces, which relation is needed for the purpose of the use of the device. For example, the imaging may purposefully contain aberrations such as axial or lateral color, spherical aberration, field curvature or distortion, for example, but not limited to these aberrations. Axial color may be arranged in order to separate image planes from different wavelengths from each other in axial direction. Axial color may be used, for example, to extend the depth-of-field. Lateral color may be arranged in order to have different magnification with different wavelengths. Distortion may be arranged desirable as needed in the use of the device. The imaging may mean diffraction limited image forming, or image forming with less accuracy than diffraction limited. The imaging may mean imaging with sufficient image quality, i.e., with a quality which sufficiently fulfills the requirements for the task the device is used.

### Pupil Imaging

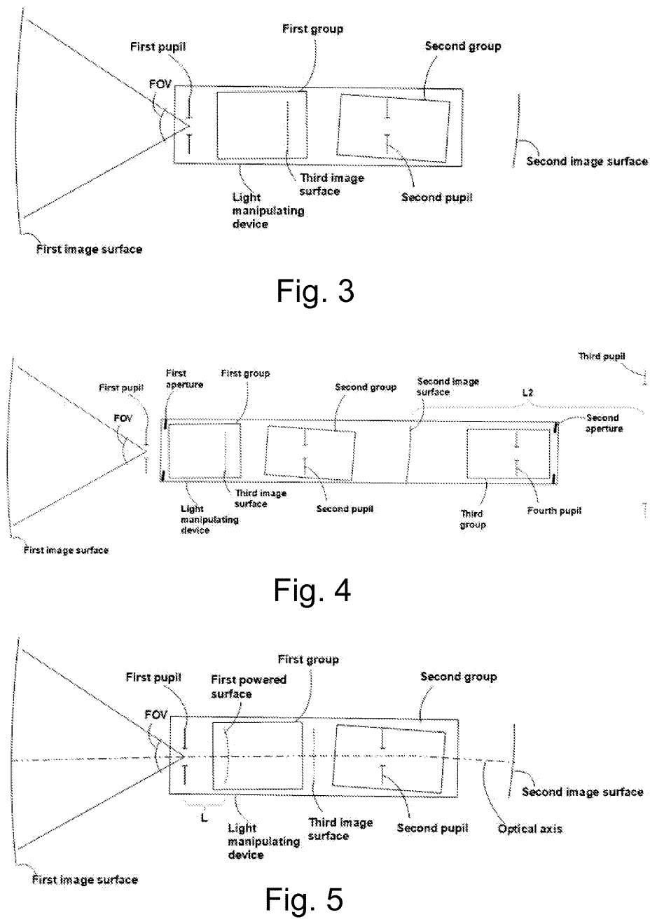

Referring to FIG. 3, the light manipulating device may be arranged to have a first pupil and the second pupil, and the light manipulating device may be arranged to image the first pupil to the second pupil. The light manipulating device may be arranged to have other pupils, such as the third pupil, the fourth pupil etc., too, some of which may be optical conjugates of the first pupil and/or the second pupil for example.

The first pupil, the second pupil, and the other pupils may be called as the device pupils. The device pupils may be located inside or outside of the light manipulating device.

The shape of the pupil may be, for example, circular, approximately circular, elliptical, oval, rectangular, distorted rectangle, square, slit, pinhole, or any shape which is needed for fulfilling the requirements of the device.

Each pupil of the device may be realized by a physical aperture or by the image of another pupil of the device. The physical aperture may comprise, for example, an aperture plate, a piece of solid material with a beam blocking edges, a piece of solid material with a hole, or an iris. The iris may have a fixed aperture, or the aperture may be adjustable. The adjustment may be manually operated or by an actuator such as a motor.

One of the device pupils may be realized by a physical aperture, and may be the aperture which defines the aperture stop of the light manipulating device. That device pupil may be called as an aperture stop. The other pupils may be images of the aperture stop.

The diameter or diagonal of the first pupil may be, for example, between 1.5 and 6 mm, or, for example, between 0.1 mm and 8 mm.

The first pupil may work as the aperture stop. The first pupil may be implemented by a physical aperture, which may be adjustable or replaceable so that the size and/or shape of the aperture stop can be varied.

The second pupil may work as the aperture stop. The second pupil may be implemented by a physical aperture, or, for example, by adjustable iris diaphragm so that the diameter of the aperture stop can be varied. The physical aperture may also be arranged to be replaceable in order to be able to vary the size and/or shape of the aperture stop.

### Image Side Telecentricity

The first pupil and/or the second pupil may be imaged to the third pupil, which acts as a pupil when viewed from the second image surface. The distance between the third pupil and the second image surface may be, for example, larger than 500 mm, or larger than 1000 mm for example. The light manipulating device may be a lens system, and the second image surface may be the image plane of the lens system, and the distance between the third pupil and the second image surface may mean that the lens system is arranged to be approximately telecentric in image side.

Some of the advantages of the telecentricity are, for example, that magnification becomes less dependent on the focus, and that the angular distribution of light is substantially equal over the field-of-view. Substantially constant angular distribution over the field-of-view is advantageous as it allows using filters such as dichroic filters so that the filter operates substantially equally over the field-of-view. This may be important advantage, for example, when performing spectral measurements, such as color measurement, over the field-of-view.

This telecentricity is not limited to the second image surface only, but the light manipulating device may be arranged to be telecentric in any position where needed for achieving needed operation. Similarly, the light manipulating device may have arranged to have needed angular distribution of rays where needed for achieving the desired operation, for example, for use of optical components which require certain specific angular distribution, or for other reasons. The angular distribution at specific locations may be expressed by specific chief-ray-angle vs. field coordinate-dependency, or, for example, specific marginal ray angle vs. pupil coordinate-dependency.

### Illumination Pupil As Aperture Stop

FIG. 4 shows an embodiment of the light manipulating device, having the third group and the fourth pupil, which acts as the aperture stop. The fourth pupil may be implemented by a physical aperture, or, for example, by adjustable iris diaphragm so that the diameter of the aperture stop can be varied. The physical aperture may also be arranged to be replaceable in order to be able to vary the size and/or shape of the aperture stop. The part of the third group between the fourth pupil and the second group images the fourth pupil to the third pupil, which is a virtual image of the fourth pupil when viewed from the second image surface, and which is located further than, for example, 500 mm or, for example, further than 1000 mm distance L2 from the second image surface. Although drawn on the right side, the third pupil may be imaged on either side of the second image surface. By this way, the light beam can be arranged to be substantially or close to telecentric at the second image surface. However, distance L2 may also be less than 500 mm, and the beam can be arranged to be non-telecentric at the second image surface as well when needed. The fourth pupil is further imaged to the second pupil and to the first pupil, which do not need to have physical apertures, but may still have physical apertures, for example, for improving stray light performance of the optical system. The first pupil may be located outside the light manipulating device and form an external pupil for the optical system. In this arrangement the light may propagate, for example, in direction from the second aperture to the first aperture. The second image surface may have a spatial modulator, such as a reticle, LCD, or DMD, for example, and the light manipulating device may work as projector optics which projects the image formed by the spatial modulator to the first image surface through the first pupil, which may be an external pupil.

### Components

The light manipulating device may comprise components such as optical, mechanical and/or electrical components, or groups of such components. The components may be for example, but not limited to, lenses, optical windows, prisms, lightpipes, lightguides, optical fibers, optical fiber arrays, fiber bundles, optical filters, dichroic filters, interference filters, apertures, iris diaphragms, mirrors, diffractive gratings, holographic elements, Fabry-Perot filters, photonic crystals, diffuse elements, polarizers, depolarizers, waveplates or retarders, aberration compensation plates, beamsplitters, optical coatings, Fresnel lenses, adaptive optical components, active-or passive optical components, optomechanical components or parts, lens barrels, spacers, nuts, retainer rings, just to mention some.

### Lenses

The lenses may be components or systems which refract at least portion of light in the operation wavelength range. The lenses can be, for example, singlet lens elements, such as convex lenses, concave lenses, or meniscus lenses. The lenses may also be groups of lens elements, such as doublets and triplets for example, which may be air-spaced or cemented. The lenses may comprise adjustable optics such as focus tunable lenses or liquid lenses for example. The lenses may have positive or negative optical power. The lenses may contain, for example, spherical, aspherical, or diffractive surfaces. The lenses may be refractive lenses, diffractive lenses, hybrid diffractive-refractive lenses, hybrid diffractive lenses, gradient index lenses, achromats, biconic lenses, cylindrical lenses, axicons, prismatic lenses, anamorphic lenses, or catadioptric lenses for example. Lenses may, for example, be integrated with a mirror or prism or with any other component.

### Mirrors

The mirrors may be components which reflect at least portion of light in the operation wavelength range. A mirror may be a reflecting or semi-reflecting device. The reflection may be arranged to happen, for example, from a metal material, a metal coating, a thin-film coating, a dichroic coating, or combination of these. The reflection may be arranged to happen by the difference in refractive index in the interface between two optical materials. The reflection may be arranged to happen by the total-internal-reflection (TIR) phenomena in an interface between two optical materials with different index of refraction. Mirrors may be integrated with some other components such as a lens or prism for example, too. The shape of the reflecting surface may be, for example, planar, curved, conical, parabolic, elliptic, hyperbolic, off-axis conic, axicon, cylindric, anamorphic, or biconic. The reflection may be arranged by a diffractive pattern on a surface. The reflecting surface may be a hybrid diffractive-refractive surface, or hybrid diffractive-refractive-reflective surface. The lenses and mirrors may be arrays of lenses or mirrors, such as microlens arrays, lenslet arrays, or micromirror arrays. The array may by arranged in one or two dimensions, too.

### Glass Materials

The lenses may be partially or fully made of at least partially transparent material in some wavelength in which the light manipulating device is operating. The lenses may contain optical material such as inorganic glass, for example, inorganic compound glass, pure glass material, for example, fused silica glass, silicate glass, crystalline optical materials, semiconductor materials, polycrystalline ceramics, organic polymers, for example, optical plastics, or liquids for example. Some of the lenses may be made of low-dispersion glass (LD glass), special low dispersion glass (SLD glass), extraordinary low-dispersion glass (ELD glass), extra-low-dispersion glass (ED glass), ultra-low-dispersion glass (UL glass), for example, too. In addition to that, one or some of the lenses may be made of low refractive index material, high refractive index material, or material with refractive index below unity or below zero.

### Groups

For the purpose of description, the components may be arranged to light manipulating groups, or shortly called groups, each of which may contain at least one component. The groups may also share mutual components. A component, which is physically one part may also partially belong to one group, whereas the other portion of the same component may belong to another group. Several components may be integrated to one physical part.

The light manipulating device may comprise other groups than described, too, for example, as needed for fulfilling the needs for each use case in question.

### The First and the Second Group and the Intermediate Image

Referring to FIG. 3 again, the light manipulating device may have at least two light manipulating groups: the first group and the second group. The first group may have positive optical power. The second group may have positive optical power. The first group may form an image of the first image surface to the third image surface, and the second group may form an image of the third image surface to the second image surface. The third image surface may be called as an intermediate image, which may be real or virtual image of the first image surface.

### Optical Axis

An optical axis may be defined to the light manipulating device. The optical axis may be defined as understood in context of optical systems in general. The optical axis may be an imaginary path along which light beam propagates through the device. In some light manipulating groups the optical axis may approximately coincide with the axis of rotational symmetry of optical surfaces for example. The optical axis may be folded by a fold mirror, a prism, a mirror, or a diffractive optical element for example, or by some other optical component. The optical axis may comprise several linear segments.

### Working Distance

FIG. 5 depicts an embodiment of the light manipulating device with the first working distance L along the optical axis between the first pupil and the first powered surface. The first powered surface may, for example, be the first curved lens surface of the device from the same side than the first pupil is located in respect to the device.

The first working distance L may be arranged to be, for example, larger than 1 mm optical distance, or, for example, larger than 15 mm optical distance, or, for example, larger than 22 mm optical distance.

As depicted in FIG. 5 the optical components in the light manipulating device may be divided to the first group and to the second group. The second pupil may be located inside the second group, and the part of the second group located between the second pupil and the first group, together with the first group, may image the second pupil to the first pupil.

In the direction of the light propagation from the second image surface to the first image surface, the first powered surface may be the last optical interface having substantially non-zero optical power in the first group. However, there may be optical surfaces with power after the first group, too.

### Aberration Compensation Between the First Group and the Second Group

The first group may image the first image surface to the third image surface, and the second group may image the third image surface to the second image surface. The third image surface may be real image of the first images surface, so the light manipulating device may be a double-imaging system, such as a double-imaging lens.

The aberrations compensation may be arranged in the first group and the second group individually. i.e., the first group may correct optical aberrations sufficiently so that the third image surface is an image of the first image surface with sufficient image quality. The second group may correct optical aberrations sufficiently so that the second image surface is an image of the third image surface and the first image surface with sufficient image quality. An advantage of this individual aberration compensation is modularity and versatility, i.e., for example, it may allow the first group and the second group be easily replaced.

The aberration compensation may be arranged to be partially mutual between the first group and the second group, i.e., at least one, two, or three of the following aberrations may not be corrected by the first or the second group alone, but together: field curvature, lateral color, and astigmatism. So, at least one of these aberrations are uncorrected by the first group, and the correction is made in the second group so that the second image surface is an image of the first image surface with sufficient quality.

An advantage of this mutual aberration compensation is that it allows larger etendue (i.e., throughput, i.e., product of FOV and pupil size) to have sufficient optical performance with smaller number of optical components.

The imaging of the first image surface to the third image surface may be called as the first imaging, and the imaging of the third image surface to the second image surface may be called as the second imaging. An advantage of double-imaging configuration is that it allows above-described mutual aberration compensation, where the first imaging does not compensate all aberrations, i.e., does not form aberration free image to the third image surface, but the second imaging compensates the aberrations so that the second image surface has sufficient image quality. This simplifies the overall optical system, and enables smaller size and lower cost.

The same may be arranged in opposite direction as well, i.e., in the double-imaging configuration the second imaging does not need to compensate all aberrations, i.e., does not need to form aberration free image from the second image surface to the third image surface, but the first imaging may compensate the residual aberrations so that the first image surface is sufficiently aberration free image of the second image surface.

### Folding

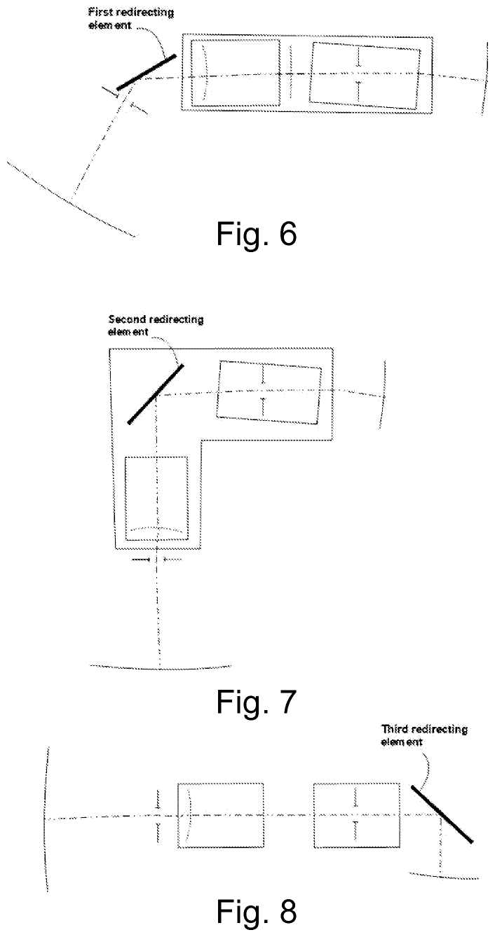

The light manipulating device may have at least one optical component which may be called as a light redirecting element. The light redirecting elements may re-direct the beam of light as a whole, or at least most of the beam. The light redirecting element may comprise, for example, at least one of a fold mirror, a prism, a diffraction grating, an optical fiber, an optical fiber bundle just to mention some. FIGS. 6 to 15 show exemplary configurations with the light manipulating device with light redirecting element.

An advantage of some configurations of the light manipulating device may be that it has enough space between the first pupil and the first group in order to be able to fit a light redirecting element there between. FIG. 6 shows the light manipulating device, configured to be able to have a first light redirecting element between the first pupil and the first group.

An advantage of some configurations of the light manipulating device may be that it has enough space between the first powered surface and the second image surface in order to be able to fit a light redirecting element there between. FIG. 7 shows the light manipulation device, configured to be able to have a second light redirecting element between the first powered surface and the second image surface. In this exemplary case, the second light redirecting element is between the first powered surface and the second pupil.

An advantage of some configurations of the light manipulating device may be that it has enough space between the first powered surface and the second pupil in order to be able to fit a light redirecting element there between.

An advantage of some configurations of the light manipulating device may be that it has enough space between the second pupil and the second image surface in order to be able to fit a light redirecting element there between. FIG. 8 shows the light manipulation device, configured to be able to have a third light redirecting element between the second pupil and the second image surface.

Note that although the light manipulating device has been configured to have ability to have the light redirecting element, the same light manipulating device may be possible to use without the light redirecting element. The light manipulating device may be configured to have ability to have multiple light redirecting elements at the same time.

Some advantages of having light redirecting element are for example: the ability to fit the light manipulating device to a restricted or smaller space, or to a certain form, and the ability to bring at least two light manipulating devices closer to each other.

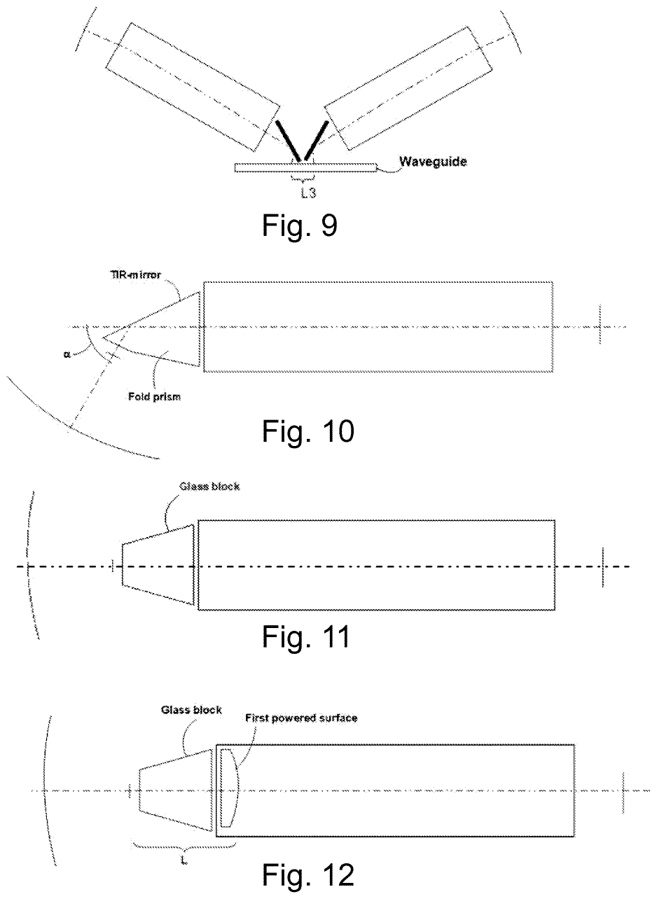

FIG. 9 presents an advantage of the light redirecting element. Two light manipulating devices both have the first light redirecting elements. Both of these light manipulating elements are arranged to the same side of an optical waveguide for performing optical measurements. By the help of the light redirecting elements, it is possible to bring the two light manipulating devices closer to each other than without light redirecting elements, i.e., it is possible to minimize the distance L3 between the optical axes of the light manipulating devices on the waveguide. The waveguide may be, for example, such as used in augmented reality (AR) or virtual reality (VR) displays. The other light manipulating device may operate as a part of a projector, as a projection lens for example, delivering beam to the waveguide, and the other light manipulating device may operate as camera lens capturing some of the outcoupled beam from the waveguide.

### Fold Prism

FIG. 10 shows an embodiment of the light manipulating device, with the first light redirecting element implemented by a prism. The light is reflected by total-internal-reflection from a surface called TIR-mirror. The direction of the optical axis changes by an angle is called as a fold angle and is denoted by a in the figure. The fold angle a may be, for example, between 10 and 170 degrees, or between 30 and 90 degrees for example. Total-internal-reflection works with smaller fold angles a, and with larger fold angles when total-internal-reflection may not be usable, the TIR-mirror surface may be mirror coated. The TIR-mirror surface may be mirror coated with smaller fold angles a as well. With larger fold angles a there may be a mirror next to the TIR-mirror surface substantially parallel to the TIR-mirror surface for example, reflecting the light instead of total-internal-reflection.

An advantage of the fold prism is that it may be very versatile, so that the same optical configuration can be used with different fold angles by varying, for example, only the fold prism. An advantage of the fold prism is that the same optical configuration may be used without the fold prism by replacing the fold mirror by a block of glass material, such as glass window, with equal optical thickness than the folded path through the prism.

FIG. 11 shows otherwise the same light manipulating device than FIG. 10 but in which the fold prism is replaced by a glass block which is optically substantially equivalent to the fold prism but does not fold the beam.

The aberrations caused by the fold prism and/or the glass block, such as astigmatism, spherical aberration and lateral and axial chromatic aberrations for example, may be arranged to be sufficiently compensated by the other optical components, such as by the other lenses or mirrors in the light manipulating device. By that way, high optical performance may be achieved when having the fold prism and/or glass block in the position of the first light redirecting element.

### Maximizing FOV With Fold Prism

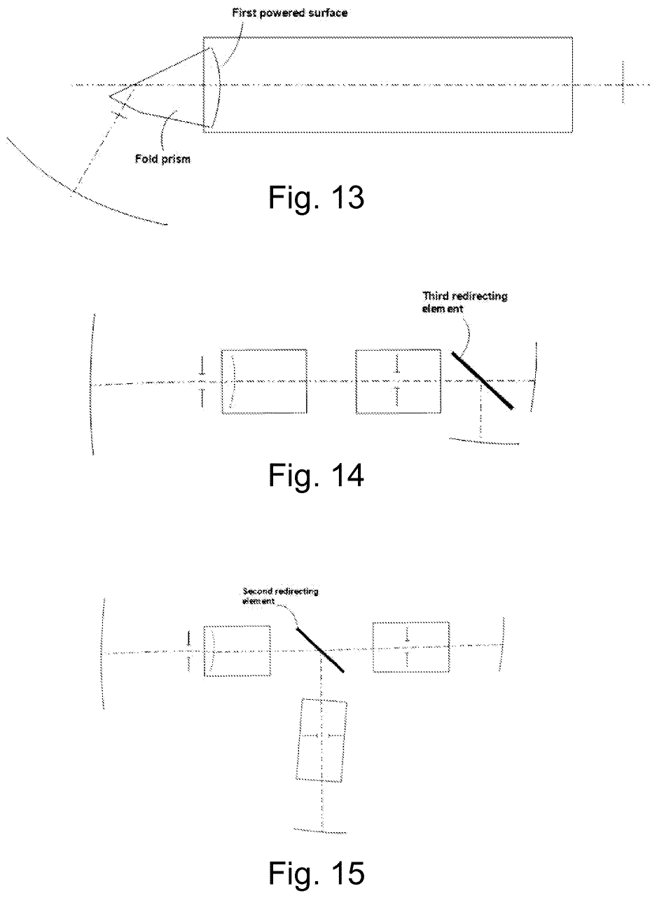

FIG. 12 shows a configuration of the light manipulating device having the glass block between the first pupil and the first group. The first working distance L along the optical axis between the first pupil and the first powered surface may be optimized large enough to allow replacing the glass block by a fold prism with a desired fold angle, still achieving the needed field-of-view and pupil size. The glass block may be made of material with high index of refraction (IOR), such as higher than 1.8, or higher than 1.65 for example. An advantage of high IOR material is that it increases the optical path length through the glass block compared to lower IOR material, and so allows higher field-of-view through the fold prism. The optical distance between the first pupil and the first powered surface may be arranged to be, for example, more than 15 mm or more than 20 mm, or more than focal length of the light manipulating device, or more than 1.4 times the focal length for example. That optical distance may allow replacing the glass block by a fold prism while preserving large field-of-view and/or high throughput, i.e., large field-of-view together with large pupil.

The versatility of the optical design and the use of the light manipulating device may be further improved by having the first powered surface to be in the lens element which is next to the glass block. This lens element may be called as the first lens element. The first lens element may be made of the same material than the fold prism, but not necessarily. The first lens element may be a plano-convex lens. The planar surface may be facing towards the prism, and the planar surface may be substantially parallel to the prism surface next to it. The planar surface may not necessarily be planar but may have weak optical power as well as the prism surface next to it. Some or all of these features may allow the optical thickness of the glass block and the optical thickness of the first lens element to be variable without substantially altering the optical operation or performance of the light manipulating device. When the glass block is replaced by another glass block or prism with different optical path length, the difference may be compensated by the thickness of the first lens element. This versatility may be an advantage and may make it possible to use the light manipulating device for wide range of purposes.

FIG. 13 shows still another configuration of the light manipulating device, where the fold prism is integrated with the first lens element so that the first powered surface is a surface of the fold prism. This may be advantageous for simplifying the overall optical construction, and may improve optical performance.

When the light manipulating device contains the fold prism, the field-of-view may be asymmetrical so that FOV is larger in the direction perpendicular to the plane of reflection, than in the direction of plane of reflection, where plane of reflection may refer to the plane of reflection defined by the optical axis before and after reflection from the TIR-surface for example. For example, the FOV may be larger than 30 deg×10 deg, or larger than 50×30 deg, or larger than 70×50 deg.

### Optionality

In general, when the light manipulating device is described to have a certain property or part, it does not mean that the light manipulating device necessarily has that property or part always in use, but it may mean that the light manipulating device has been designed and configured so that it has capability to have that property or part of it if needed in the use case in question. The light manipulating device may have optional features, properties, and parts, which have been taken account in its design, and so can be used when needed. This versatility and optionality are advantages.

### Beamsplitter

An advantage of the possibility to use the light redirecting element is the possibility to split or divide the beam by using a beamsplitter. Instead of redirecting substantially the whole beam, the light redirecting element may re-direct only a predetermined portion of the beam. The light redirecting element may operate as a beamsplitter, which divides the beam to at least two separate channels. The redirecting element may divide or spread the beam to more than two channels, too. The light redirecting element may be, for example, a beamsplitter, such as a non-polarizing beamsplitter, polarizing beamsplitter, dichroic beamsplitter, polka-dot beamsplitter, diffractive beamsplitter, diffractive element, pellicle beamsplitter, just to mention some exemplarily. The light redirecting element may also be an optical system, and may comprise a modulator, such as DMD, LCOS for example, too, which are capable of dividing a light beam to at least two beams.

FIG. 14 and FIG. 15 show exemplarily light manipulating devices the light redirecting elements working as beamsplitters. These configurations allow, for example, using two camera sensors to capture image from the same or overlapping field-of-view which is an advantage. These allow, for example, using one camera sensor for performing certain measurements, and the other camera sensor for performing other measurements which require different sensor properties. Also, these allow, for example, using one channel for illumination and the other channel for detection, for example, using one channel for projecting and the other channel for camera. In some configurations the other channel is used to project an alignment beam which may be used to align the light manipulating device to some reference body.

### Distortions and Projections

The relation between the imaging surfaces, for example imaging between them and for example the imaging between the first image surface and the second image surface, or between any imaging surfaces, may include some kind of mapping, which relates locations between the imaging surfaces to each other.

The mapping may be characterized by distortion, which may mean deviation from certain ideal mapping, such as rectilinear (or perspective) projection for example. The ideal mapping may be, for example, cylindrically symmetrical projection, such as perspective, stereographic, equidistant, equisolid, or orthographic projection for example. The ideal mapping may also be cylindrically non-symmetrical.

The mapping between the imaging surfaces, may have certain distortion in respect to equidistant projection for example, i.e., the distortion may be expressed in percentage difference to f-theta distortion. The light manipulating device may be arranged to have maximum absolute value of f-theta distortion below 5%, or below 2%, or below 1% for example.

An advantage of small f-theta distortion is that it may simplify measurements done in an angular image space, i.e., in terms of angular field-of-view.

On the other hand, the light manipulating device may be arranged to have certain deviation to rectilinear projection, such as max. 5%, or max. 2%, or max. 1% deviation for example.

An advantage of small rectilinear distortion is that it may simplify measurements done in spatial image space, i.e., in terms of spatial field-of-view.

An advantage of the light manipulating device is that it can be arranged to have desired distortion, and desired mapping, which best fits to the purpose of the use of the light manipulating device.

An advantage of the double-imaging configuration described above is that it makes possible to configure the light manipulating device to different distortion mappings easier within large field-of-view.

### Specific Features

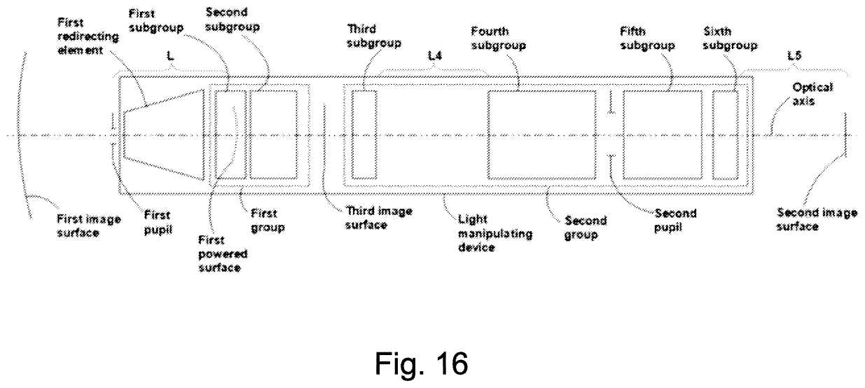

An exemplary embodiment of the light manipulating device is shown in FIG. 16. The light manipulating device is a lens which images the first image surface to the second image surface. The light manipulating device has the first group and the second group. The first group images the first image surface to the third image surface, which may be a real image, and which is located between the first group and the second group. The second group images the third image surface to the second image surface. The light manipulating device has a second pupil, located inside the second group. The second pupil is imaged to the first pupil, which is an external pupil located outside the first group. The second pupil is imaged to an entrance pupil for the second image surface, which entrance pupil may be substantially at infinity, i.e., the lens may be substantially telecentric at the second image surface.

The first image surface may be called as an object surface and the second image surface may be called as an image surface. The object surface may be located, for example, at infinity when viewed from the first pupil. The object surface may be located closer than infinity too, for example, at a distance greater than 50 mm from the first pupil, on either side of the first pupil. The lens may have field-of-view larger than 60 deg at least in one radial direction in the object side, when viewed from the first pupil. The optical performance of the lens may be optimized to be best at a certain wavelength range, for example, at a wavelength range between 400 and 700 nm, or, for example, between 430 and 670 nm.

The diameter of the first pupil may be, for example, between 0.01 and 8 mm, or, for example, between 0.1 and 6 mm, or, for example, max. 5.5 mm. The effective focal length of the lens may be, for example, between 1 and 25 mm, or, for example, between 4 and 16 mm or, for example, between 6 and 11 mm or, for example, between 8 and 9 mm. The lens may be arranged to have close to equidistant mapping, i.e., close to zero f-theta distortion, for example, smaller than 5%, or, for example, smaller than 1% f-theta distortion over the whole field-of-view, but not necessarily if it is not needed in the use of the lens. The lens may be arranged to have diffraction limited resolution, or close to diffraction limited resolution, at the center of field. The lens may be arranged to have resolution between 10 and 80 cycles/deg, or between 20 and 60 cycles/deg for example. The maximum clear aperture of the lens elements may be arranged to be, for example, between 1.0 and 2.0 times the focal length, or, for example, between 1.4 and 1.8 times the focal length, but not limited to these values. The total length of the lens from the first pupil to the second image surface may be, for example, 20-40 times the focal length of the lens, or, for example, 25-35 times the focal length, but not restricted to these values.

In FIG. 16 the first redirecting element is drawn as a glass block. As described above, the glass block may be replaceable by the fold prism, for example, and so allow redirecting the beam when needed.

The first group may contain the first and the second subgroups. Subgroups may be groups of optical components within a group. The second group may contain the third, the fourth, the fifth and the sixth subgroups. This division to subgroups is exemplary and the optical components may be divided to subgroups differently, too. There may be less or more subgroups than presented. There may be groups and subgroups other than shown here, too.

The first subgroup may have positive optical power. The first subgroup may, for example, comprise a plano-convex lens where the planar surface may be facing towards the first pupil. The convex surface may be the first powered surface described above. The lens element may have index of refraction larger than 1.75 or larger than 1.65 with the operating wavelength, but may be smaller, too. The first subgroup may contain the first lens element which contains the first powered surface. The first lens element may be integrated with the first redirecting element.

Instead of or in addition to the plano-convex element, the first subgroup may comprise a positive meniscus lens, a biconvex lens, or a positive achromat lens for example. The first subgroup may comprise more than one lens elements. The first subgroup may bend rays some amount towards the optic axis and so provide less diverging beam to the second subgroup. The first subgroup may introduce aberrations such as lateral color, spherical aberration, or astigmatism, which may be corrected by the other subgroups.

The second subgroup may have positive optical power and focus the image of the first image surface to the third image surface. The second subgroup may participate correcting lateral color and astigmatism. The second subgroup may contain, for example, an achromat doublet with positive optical power. The achromat doublet may be cemented or air-spaced. The second subgroup may contain, for example, a meniscus lens with positive optical power, too. The second subgroup may contain more than one or two lens elements, all of which may have various forms.

The first subgroup may contain, in a direction from left to right along the optical axis: a positive achromat doublet and a positive meniscus lens. The left may refer to the side of the first pupil and the right may refer to the side of the second image surface. The doublet may have positive element on left and negative element on right. The meniscus may have surface apex on the left side.

The third subgroup may have negative optical power for example. The third subgroup may participate correcting field curvature, and may participate arranging space between the third subgroup and the fourth subgroup for optional second redirecting element. The third subgroup may contain a positive meniscus lens for example. The third subgroup may contain more than one lens element, each of which may have various forms. The third subgroup may contain a negative meniscus element. The surface apex of the meniscus element may be on the opposite direction compared to the positive meniscus on the second subgroup.

The third and the fourth subgroup may be arranged to form the beam substantially telecentric between the third and the fourth subgroup. Telecentricity may be advantage in such configurations, where filters, for example interference filters, are used between the third and the fourth subgroup for filtering the spectral content of the light. However, the beam may not necessarily be arranged telecentric between the third and the fourth subgroups.

The distance between the third and the fourth subgroup may be arranged to be long enough to be able to insert, for example, filters, polarizers, or light redirecting element there between. The distance may be, for example, longer than 1.5 times the focal length of the light manipulating device, or, for example, longer than 2.5 times the focal length.

The fourth and fifth subgroups may have positive optical power for example. The second pupil may be located between the fourth and the fifth subgroups. The fourth and the fifth subgroup may mutually participate for correcting one or more of the following aberrations: spherical, coma, astigmatism, field curvature, axial color, and lateral color, for example. The fourth and fifth subgroups may contain more than one lens element each, each of which may have various forms. The fourth subgroup may contain from left to right: a group having positive optical power and a group having negative optical power. The fifth subgroup may comprise at least one achromat doublet.

The sixth subgroup may have positive optical power for example. The sixth subgroup may contain, for example, at least one achromat doublet, which can be cemented or air-spaced for example. The sixth subgroup may contain more than one lens element, each of which may have various forms.

The position of the sixth subgroup may be adjustable in axial direction. The positional adjustment of the sixth subgroup may be used to adjust the focus of the lens. The adjustment may provide, for example, focusing range from −20 diopters to +20 diopters in object space.

Instead of adjusting the position of the sixth subgroup, the focus adjustment may be implemented by adjusting position of some other subgroup, or set of different subgroups. The focus adjustment may also be implemented by adjusting the position of the lens in respect to the second image surface and/or to the first image surface.

The distance from the sixth subgroup to the second image surface may be arranged to be long enough to be able to insert, for example, filter(s), polarizer(s), or light redirecting element(s) there between. The distance may be, for example, longer than 2 times the focal length of the light manipulating device, or, for example, longer than 4 times the focal length.

### Compensators

The light manipulating device may have one or more optical components which works as compensators, which can be aligned for compensating optical aberrations. The alignment of the compensators may compensate aberrations resulting from misalignments during the manufacturing and assembly of the light manipulating device. The compensator may be, for example, an optical component which can be actively aligned in the direction of optical axis, or in the directions perpendicular to the optical axis. The compensator may be tiltable around one or more some rotation axis. The compensator may be, for example, a lens, a lens system, a mirror, a prism, or optical window just to mention some.

### Internal Field Stop Aperture

The light manipulating device may contain internal apertures for stray light suppression. In such configurations, which comprise real intermediate image, such as the third image surface described with some above-mentioned configurations, there may be a physical aperture which restricts the size and/or shape of the light beam at or close to the position of the intermediate image, and at the same time may restrict the maximum field-of-view in the image surfaces. The aperture may operate as a field stop aperture and may be called as internal field stop aperture. The advantage of the internal field stop aperture may be that it may effectively reduce the amount of stray light that can pass through the light manipulating device. The internal field stop aperture may be adjustable, or changeable in order to vary the size and/or the shape of the maximum field-of-view in the image surfaces.

### Antireflection Coatings

All or some of the optical interfaces may be antireflection coated for reducing unwanted reflections, and so maximizing the achievable contrast, and minimizing the flare and ghost images, in the imaging between the image surfaces. Antireflection coatings can be used to maximize the transmission through the light manipulating device in the certain wavelength bands, too. Antireflection coatings may be optimized to the desired operation wavelength range, which may be broadband, such as white led for example, or narrow band such as some laser wavelength band for example. The antireflection coatings may be optimized for each optical interface taking account the angular distribution of rays arriving to the optical interface in question.

### Reflective Coatings

Some of the reflecting interfaces, or semi-reflecting interfaces may be coated by reflection enhancing coatings in order to maximize reflection in specific wavelength ranges. An advantage of these coatings may include improved efficiency and reduced stray light for example.

### Form Factor, Catted Lenses

Some of the optical components may have rotationally non-symmetrical shape. For example, lenses may be manufactured to have non-rotationally symmetrical clear apertures. That may be advantageous, for example, for minimizing the size of the light manipulating device. For example, in such configurations of the light manipulating device, where field and/or pupil are asymmetrical, it might be advantageous to shape part of the lenses to have asymmetrical edges, and so minimize the size of the light manipulating device.

### Focusing Element

The light manipulating device may have at least one focusing element, which can be used to move at least one image surface in respect to the device. The focusing element may enable moving the first image plane and/or the second image plane in space.

For example, the focusing element may be used to focus the second image surface to a camera sensor, or the focusing element may be used to focus the first image surface to certain distance, for example, to infinity.

The focusing element may be a group which can be moved. The focusing element may be a lens, or a group of lens elements, which are movable in direction of the optical axis. The focusing element may be a lens, or a group of lens elements, inside the device body, which are movable in the direction of the optical axis.

The whole light manipulating device may be arranged to move in respect to the first image surface and/or the second image surface for focusing, too. In camera lens use, the distance between the lens and the camera sensor may be adjusted for focusing. In projection lens use, the distance between the reticle and the lens can be adjusted for focusing.

The focusing may be performed manually or by a motor for example.

### Focus Measurement

The light manipulating device may contain means for best focus measurement or determination.

The best focus may be found by scanning the focus, i.e., operating the light manipulating device with different focus settings and by that way finding the best working focus.

In camera lens use, the camera sensor may contain focus measurement capability, such as phase-detection focus measurement pixels for example.

The light manipulating device may contain a light redirecting element, which guides at least a portion of the light, at least occasionally, to an optical arrangement which can determine focus and/or desired focus setting. The optical arrangement may be phase-detection focus measurement arrangement, for example.

The sufficient focus setting may be determined visually observing some of the image surfaces, or automatically, for example, by using a detector.

### Beam Adjuster

The light manipulating device may contain at least one beam adjuster. The beam adjuster may consist of one or more optical components which can be adjusted for modifying some property of the light beam manipulated by the light manipulating device.

For example, the light manipulating device may adjust the lateral or axial position, or directional or rotational alignment, of one of the image surfaces or device pupils. The beam adjuster may adjust the imaging function between the first image surface and the second image surface for example. The beam adjuster may adjust aberration compensation in the imaging function. The beam adjuster may adjust image mapping between the first image surface and the second image surface for example, or between any image surfaces or pupil surfaces for example. The beam adjuster may adjust the focus, i.e., adjust the axial position of the first image plane and/or the second image plane in respect to the light manipulating device.

The beam adjuster may comprise one or more optical components whose position is adjusted in one or more spatial dimension, or whose angular or rotational alignment is adjusted. The beam adjuster may comprise one or more optical components whose shape or optical properties, such as index of refraction for example, can be adjusted. The beam adjuster may comprise a liquid lens for example. The beam adjuster may contain at least one optical modulator. The beam adjuster may comprise an aperture, beam blocking element, or iris, whose shape, size, or position may be adjusted.

The beam adjuster may be operated manually or it may be motorized for example.

### Adjustable Iris

The beam adjuster may adjust physical aperture close or at one of the device pupils. The light manipulating device may contain physical aperture at least close or at one of the device pupils, whose position may be adjustable in at least one spatial or angular dimension. An advantage of the positional or angular adjustment of the aperture is that the pupil position and angle may be adjusted, for example, for compensating manufacturing tolerances, alignment tolerances, or chromatic aberrations or other aberrations in different use cases for example. The adjustment may be manual or motorized for example.

### Zoom

The beam adjuster may adjust magnification, or local magnification, between at least two image surfaces such as between the first image surface and the second image surface. On the other words, by having such beam adjuster, which may be called as a zoom adjuster, the light manipulating device may contain zoom functionality. The zoom adjuster may contain, for example, at least one group whose position is adjustable along the optical axis. The zoom adjuster may contain more than one group whose position is adjustable. The zoom adjuster may also contain at least one element whose focal length is adjustable, such as a liquid lens for example. The zoom adjuster may be operated manually or by a motor for example.

### Polarization

The light manipulating device may contain optical components which are capable to alter polarization state of the light. The light manipulating device may contain, for example, at least one polarizer and/or at least one waveplate or a combination of them, or, for example, a polarizing beamsplitter.

The polarizer may be a linear polarizer for example. For example, in camera use, a polarizer may be used for capturing images with specific polarization state, and in projector use, the polarizer may be used to project light with specific polarization state.

In combined projector and camera use, a combination of polarizer and quarter-waveplate may be used to prevent reflections from projected light to propagate backwards in the light manipulating device.

### Use of the Device

The light manipulating device may be used as a part of a measurement instrument, but not limited to that. The measurement instrument may measure properties of light, which may be emitted, transmitted, or reflected by some device, which may be called a device under test (DUT), for example.

The device under test may be, for example, a display, a projector, a screen, a waveguide, or a light guide. The device under test may be, for example, a part of a mobile device, such as a mobile phone, or an augmented reality or virtual reality headset.

The measured properties may include, for example, one or more of the following: brightness (such as radiance, luminance, irradiance, illuminance, radiant intensity, luminous intensity for example), uniformity and color uniformity, spectrum, color, resolution, modulation transfer function (MTF), field-of-view, pupil size, distortion, focus, depth-of-field, contrast (ANSI contrast for example), straylight, flare, ghost images, black level, noise, and frame rate, just to mention some.

The measurement of the properties of light may be used to analyze the manufacturing quality of the device under test. The measurement instrument may be a stand-alone instrument, or the measurement instrument may be integrated into a production line inspecting manufacturing quality during the manufacturing process.

### Camera Lens Use

The light manipulating device may be used to receive light and deliver at least part of the received light to at least one detecting element.

The light manipulating device may be used to receive light and deliver at least part of the received light to another device. The light manipulating device may be used to receive light and deliver at least part of the received light to a device under test. The light manipulating device may receive light from the device under test and deliver at least part of the received light to at least one detecting element.

The light manipulating device may be used as a camera lens. The light manipulating device may be used as a projector lens. The light manipulating device may be a camera or a projector or a combination of them.

The detecting element may be positioned, for example, close or at the second image surface. The detecting element may be positioned to measure beam properties at or close to any image surfaces. The detecting element may be positioned to measure beam properties at or close to any device pupil.

### Detecting Element

The detecting element may be any device capable of detecting electromagnetic radiation.

The detecting element may contain a light detector such as Silicon or InGaAs, organic photodetector (OPD) or pyroelectric detector for example. The detecting element may contain an array of light detectors. The detecting element may contain one or more line sensors, or matrix sensors, such as CCD (charge-coupled device), EMCCD (electron-multiplying charge-coupled device), CMOS (complementary metal oxide semiconductor) sensor, back-illuminated CMOS sensor, stacked CMOS sensor, NMOS (N-type metal-oxide-semiconductor logic) sensor, or X3 sensor (such as Foveon X3 sensor).

The detecting element may be, for example, any detector or camera system, for example, camera, line camera, light power meter, color sensor, colorimeter, time-of-flight camera, light field camera, spectrometer, wavefront sensor, or interferometer.

The detecting element may be, for example, eye, for example, human eye, or an optical instrument viewed by eye, such as microscope or telescope for example.

### Projector Lens Use

The light manipulating device may be a projector or a part of a projector, for example, a projection lens. The light manipulating element may receive light from an image forming element, and project at least a part of that light forward forming image of the image forming element to a desired location.

The image forming element may form an image to the second image surface from which the light manipulating device may project the image to the first image surface. The light forming element may form an image to the first image surface from which the light manipulating device may project the image to the second image surface.

The image forming element may contain, for example, an illuminated reticle, transparency, or a modulator for example. The image forming element may contain, for example, a display or a microdisplay. The image forming element may contain a projector, or any device which is capable of forming a beam of light. The image forming element may be a piece of material which is capable of reflecting or transmitting light, such as ambient light, or light emitted by a light source.

The image forming element may contain a light source such as LED (light emitting diode), laser, incandescent lamp, fluorescent lamp, arc-lamp, short arc lamp, Xenon lamp, high-intensity discharge lamps, plasma lamp, solid-state light, or any natural light source such as Sun or stars for example. A device or a piece of material which emits electromagnetic radiation may be used as a light source in some configurations.

The image forming element may be varied, or the image forming element may be capable of varying the image content. Such image forming element may be called as a variable image forming element. Varying image content may be implemented, for example, by the use of a display or replaceable reticles or transparencies, or, for example, by using more than one light source whose intensity may be varied.

Some advantages of using variable image forming element may be that it may allow versatile use of the light manipulating element, for example, to allow performing several different measurements accurately and fast.

### Projector and Camera Lens Use

The light manipulating device can be used to perform optical measurements. One such configuration may contain at least one device for illumination purpose, which device may be called as an illumination device, and at least one device for detection purpose, which device may be called as a detection device.

The illumination device may illuminate a target, such as a device under test for example, which may manipulate the light beam, and at least partially reflect or transmit the light, which may be at least partially captured by the detection device.

The illumination device may contain at least one light manipulating device, which may form a part of a projector for example, or may form a projector lens for example. The detection device may contain at least one light manipulating device, which may form a portion of a camera system for example, or may form a camera lens for example.

The same light manipulating device may operate both as a light manipulating device of an illumination device and as a light manipulating device of a detection device simultaneously. A light manipulating device of an illumination device and a light manipulating device of a detection device may partially share the same light manipulation device, too. The sharing may be implemented by the use of at least one light redirecting element for example.

An advantage of the light manipulating device is that it may be used both in the illumination device and in the detection device.

### Use With Modulators

The light manipulating device may contain at least one modulator. The modulator may perform modulation of light in spatial domain, angular domain, amplitude, polarization, wavefront phase, focus, spectral domain, or time domain for example. The modulator may be located in field. i.e., close or at one of the image surfaces, or pupil, i.e., close or at one of the device pupils, or anywhere in the optical path where desired function is obtained. The spatial modulator may contain, for example, DMD (digital micromirror device), LCD (liquid crystal display), LCOS (liquid crystal on silicon), MEMS (microelectro-mechanical) device, filter wheel, rotating window, variable aperture, or replaceable and/or movable reticle. The angular modulator may contain, for example, MEMS mirror, MEMS scanner, DMD, acousto-optic modulator, rotating mirror or mirrors, or rotating prism. Amplitude and phase modulator may be implemented, for example, by using some of the abovementioned spatial or angular modulators, too, combined with other optical components such as apertures, filters, waveplates, or diffractive elements for example. Modulators may also contain other adjustable, adaptive or variable components, for example, liquid lenses and Fabry-Perot modulators just to mention some.

The modulator can be used, for example, to select specific portion of field, pupil, wavelength spectrum, and polarization at specific time to be manipulated by the light manipulating device. An advantage of the use of modulator is that it may allow to use the light manipulating device in wide variety of ways, which may be advantageous in measurement use for example.

### Eye Mimicking Lens

The light manipulating device may contain a lens system, which mimics optical function or anatomy of an eye, which eye may be, for example, an eye of a mammal, or, for example, an eye of human. The optical function may mimic the function of a standard eye model, for example, such as Liou and Brennan eye model, Emsley model, or Emsley-Gullstrand model. The light manipulating device may image the first image surface to the second image surface, where the second image surface may mimic the retina of the eye. The light manipulating device may have entrance pupil diameter within the range of the eye or eye model. The light manipulating device may have field-of-view more than 60 deg at least in one radial dimension. The light manipulating device may have field-of-view more than 90 deg at least in one radial dimension. The light manipulating device may have focusing range within the range of the eye or eye model, for example, ranging from −20 to +20 diopters around infinity. The light manipulating device may operate in wavelengths which are visible by eye, for example, by human eye. The light manipulating device may have, but does not necessarily have, angular resolution close to the resolution of human eye, at least close to the optical axis. However, the focal length of the light manipulating device may differ from the focal length of the eye. The light manipulating device may be used to image a view to a sensor, in order to analyze how the view would be viewed by the eye. In addition to that, the light manipulating device may be used to project a spatial pattern from the position of the sensor, mimicking retina, to another optical device, in order to analyze the projected beam.

An advantage of arranging the light manipulating device to mimic the eye is, for example, that it can be used to measure accurately and fast how displays, for example, AR or VR headsets displays, are viewed by eye.

### Attachments

The light manipulating device may contain, or receive light from, or deliver light to, at least one of the following devices or components: optical fiber, optical fiber bundle, imaging optical fiber bundle, eye glasses, prism, close-up lens, teleconverter, microscope, telescope, field relay lens, pupil relay lens, periscope, spectrograph, spectrometer, monochromator, power meter, confocal microscope, confocal sensor, pinhole, scanning laser, or optical coherence tomography (OCT) device, for example.

### General Advantages

Some advantages of the described light manipulating device are for example:
Versatility, the same light manipulating device can be used to wide variety of different purposes
Modularity, the same light manipulating device may be varied to different purposes
High optical performance
Large field-of-view
Large throughput
Versatile form factor, the same light manipulating device can be folded to various forms
External pupil with large working distance
Foldability between the external pupil and the lens, which allows projecting and detecting with two light manipulating devices close to each other.

1. A light manipulating device comprising:
a first aperture for entering light into the light manipulating device;
a second aperture for outputting light propagated through the light manipulating device;
wherein the light manipulating device is configured to image a first image surface visible by the first aperture via the light manipulating device and through the second aperture to a second image surface.

2. The light manipulating device according to claim 1 comprising an optical system for manipulating light by using one or more optical components.

3. The light manipulating device according to claim 2, said optical system comprising one or more of a lens, a mirror, a diffraction grating, or a light modulator.

4. The light manipulating device according to claim 1, 2 or 3, said optical system comprising at least one lens, wherein the first image surface is an object plane of the lens and the second image surface is an image plane of the lens, or the second image surface is the object plane of the lens and the first image surface is the image plane of the lens.

5. The light manipulating device according to any of the claims 1 to 4 comprising at least one further image surface.

6. The light manipulating device according to claim 5, wherein said at least one further image surface comprises at least one image surface which is a conjugate to at least one of the first image surface and the second image surface.

7. The light manipulating device according to any of the claims 1 to 6 comprising a first pupil and a second pupil, wherein the light manipulating device is configured to image the first pupil to the second pupil.

8. The light manipulating device according to claim 7, wherein each pupil is realized by a physical aperture or by an image of another pupil of the device.

9. The light manipulating device according to claim 7 or 8, wherein the first pupil is configured to be operating as an aperture stop.

10. The light manipulating device according to any of the claims 1 to 9 comprising optical, mechanical and/or electrical components, or groups of such components.

11. The light manipulating device according to claim 10, wherein the components comprise one or more of the following: lenses, optical windows, prisms, lightpipes, lightguides, optical fibers, optical fiber arrays, fiber bundles, optical filters, dichroic filters, interference filters, apertures, iris diaphragms, mirrors, diffractive gratings, holographic elements, Fabry-Perot filters, photonic crystals, diffuse elements, polarizers, depolarizers, waveplates or retarders, aberration compensation plates, beamsplitters, optical coatings, Fresnel lenses, adaptive optical components, active-or passive optical components, optomechanical components or parts, lens barrels, spacers, nuts, retainer rings.

12. The light manipulating device according to any of the claims 1 to 11 comprising at least a first light manipulating group and a second light manipulating group, wherein the first group is configured to form an image of the first image surface to a third image surface, and the second group is configured to form an image of the third image surface to the second image surface.

13. The light manipulating device according to claim 12, wherein the first light manipulating group is configured to perform aberration compensation when forming the third image surface from the first image surface, and the second light manipulating group is configured to perform aberration compensation when forming the second image surface from the third image surface.

14. The light manipulating device according to any of the claims 1 to 13 comprising at least one light redirecting element.

15. The light manipulating device according to any of the claims 1 to 14 comprising a glass block in front of the first aperture.

16. The light manipulating device according to any of the claims 1 to 15 comprising a light manipulating element the location of which is adjustable in an axial direction of the light manipulating device.

17. The light manipulating device according to any of the claims 1 to 16 having an operation wavelength, wherein the light manipulating device comprises one or more light manipulating elements configured to restrict the operation wavelength.

18. A method for manipulating light by a light manipulating device, the method comprising:
entering light into the light manipulating device via a first aperture;
outputting light propagated through the light manipulating device via a second aperture;
wherein the method further comprises imaging a first image surface visible by the first aperture via the light manipulating device and through the second aperture to a second image surface.
